(19) United States
(12) Patent Application Publication
(10) Pub. No.: US 2024/0178439 A1
(43) Pub. Date: May 30, 2024

(54) NON-AQUEOUS RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Shota UCHIYAMA, Kobe-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/516,165

(22) Filed: Nov. 21, 2023

(30) Foreign Application Priority Data
Nov. 28, 2022 (JP) 2022-189308

(51) Int. Cl. H01M 10/0525; H01M 4/134; H01M 10/0585; H01M 50/103

(52) U.S. Cl. CPC H01M 10/0525; H01M 4/134; H01M 10/0585; H01M 50/103; H01M 2004/021

(57) ABSTRACT

In an insulating protective layer formed on each of two opposite surfaces of a positive electrode connection portion, a yield stress X (N) of a positive electrode plate is set such that “X≤0.122 N” is satisfied. “M_{IN}≥0.0372 N” is satisfied, where M_{IN} (N) represents a flexural strength of the positive electrode plate including only an inner insulating protective layer formed on a surface of the positive electrode connection portion that is located toward a positive electrode current collector in a stacking direction of an electrode body.

### BACKGROUND

### 1. Field

The following disclosure relates to a non-aqueous electrolyte rechargeable battery, and more particularly, to a non-aqueous electrolyte rechargeable battery that includes an insulating protective layer and reduces the load on separators and the like.

### 2. Description of Related Art

Non-aqueous electrolyte rechargeable batteries, such as lithium-ion rechargeable batteries, have a high energy density and a high capacity. Thus, a non-aqueous electrolyte rechargeable battery is used as a stationary battery or as a power supply for driving a battery electric vehicle (BEV), a hybrid electric vehicle (HEV), or the like.

A typical lithium-ion rechargeable battery includes an electrode body formed by a stack of a positive electrode plate, a negative electrode plate, and separators. The electrode body is accommodated in a battery case filled with an electrolyte solution. In recent years, rolled-type lithium-ion rechargeable batteries have been widely used because of their high efficiency and compact size. In such battery, strips of a positive electrode plate, a negative electrode plate, and separators are stacked one on top of another. Then, the stack is rolled in a longitudinal direction, and the roll is compressed to form an electrode body that is accommodated in a battery case.

FIG. 5A is a schematic diagram showing a cross section of an electrode body 10 of a typical lithium-ion rechargeable battery 1 taken along line A-A in FIG. 3. In a step of manufacturing the electrode body 10, a negative electrode plate 100, a positive electrode plate 110, and separators 120 are stacked. FIG. 5B is a schematic diagram showing a cross section of the electrode body 10 of the typical lithium-ion rechargeable battery 1 taken along line A-A in FIG. 3. In a step of manufacturing the electrode body 10, opposing parts of a negative electrode connection portion 103 are joined together and welded to a negative electrode current collector 13, and opposing parts of a positive electrode connection portion 113 are joined together and welded to a positive electrode current collector 15.

Japanese Laid-Open Patent Publication No. 2021-089857 describes an electrode body formed by such stacking of a positive electrode plate, a negative electrode plate, and separators. As shown in FIG. 5A, distal end parts of the negative electrode plate 100 extending out of the stack and arranged one over another form a negative electrode connection portion 103, and distal end parts of the positive electrode plate 110 extending out of the stack and arranged one over another form a positive electrode connection portion 113. As shown in FIG. 5B, the opposing parts of the negative electrode connection portion 103, serving as a current collector, at one end of the electrode body 10 in a widthwise direction W are joined together and bonded to the negative electrode current collector 13. In the same manner, the opposing parts of the positive electrode connection portion 113 at the other end of the electrode body 10 are joined together and bonded to the positive electrode current collector 15.

### SUMMARY

When joining the opposing parts of the connection portion, the opposing parts at the outward part of the electrode body 10 are bent by a greater angle than the opposing parts at the inward part of the electrode body 10. When the connection portion is bent by a large angle, stress concentrates at the bent portion. This applies a load to a substrate formed by a metal foil, a mixture layer including resin, thin resin separators, and the like.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous electrolyte rechargeable battery includes an electrode body including a stack of a negative electrode plate, a positive electrode plate, and a separator arranged between the positive electrode plate and the negative electrode plate. The negative electrode plate includes a negative electrode substrate formed by a strip of a metal foil having a uniform width, a negative electrode mixture layer formed on each of two opposite surfaces of the negative electrode substrate, and a negative electrode connection portion defined on the negative electrode substrate where the negative electrode mixture layer is not formed at one end of the electrode body in a widthwise direction. The positive electrode plate includes a positive electrode substrate formed by a strip of a metal foil having a uniform width, a positive electrode mixture layer formed on each of two opposite surfaces of the positive electrode substrate, a positive electrode connection portion defined on the positive electrode substrate where the positive electrode mixture layer is not formed at an other end of the electrode body in the widthwise direction, and an insulating protective layer arranged on each of two opposite surfaces of the positive electrode connection portion. The insulating protective layer is adjacent to the positive electrode mixture layer and facing the negative electrode mixture layer. The non-aqueous electrolyte rechargeable battery further includes a negative electrode current collector bonded to the negative electrode connection portion at where opposing parts of the negative electrode connection portion are joined to one another at the one end of the electrode body in the widthwise direction, and a positive electrode current collector bonded to the positive electrode connection portion at where opposing parts of the positive electrode connection portion are joined to one another at the other end of the electrode body in the widthwise direction. In a state in which the positive electrode mixture layer is fixed, a tip of a needle is pressed against the insulating protective layer at a contact point where the tip of the needle contacting the insulating protective layer is located at a certain distance L (mm) from a boundary between where the positive electrode mixture layer is formed and where the positive electrode mixture is not formed to measure a response load F (N) and a displacement amount S (mm). The response load F (N) that is measured when a correlation of the response load F (N) and the displacement amount S (mm) is broken corresponds to a yield stress X (N). A flexural strength M (N) is obtained by calculating “M (N)=FL/S”. In the insulating protective layer formed on each of the two opposite surfaces of the positive electrode connection portion, the yield stress X (N) of the positive electrode plate is set such that “X≤0.122 N” is satisfied. “M_{IN}≥0.0372 N” is satisfied, where M_{IN} (N) represents a flexural strength of the positive electrode plate including only an inner insulating protective layer formed on a surface of the positive electrode connection portion that is located toward the positive electrode current collector in a stacking direction of the electrode body.

In the non-aqueous electrolyte rechargeable battery, in the positive electrode connection portion where the opposing parts are joined to one another and bonded to the positive electrode current collector, “M_{OUT} (N)≥ 0.0343” may be satisfied, where M_{OUT}(N) represents the flexural strength (N) of the positive electrode plate including only an outer insulating protective layer formed on a surface of the positive electrode connection portion that is located away from the positive electrode current collector in the stacking direction of the electrode body.

In the non-aqueous electrolyte rechargeable battery, the electrode body may be a rolled-type electrode body in which the stack is rolled and flattened.

In another general aspect, a non-aqueous electrolyte rechargeable battery includes an electrode body including a stack of a negative electrode plate, a positive electrode plate, and a separator arranged between the positive electrode plate and the negative electrode plate. The negative electrode plate includes a negative electrode substrate formed by a strip of a metal foil having a uniform width, a negative electrode mixture layer formed on each of two opposite surfaces of the negative electrode substrate, and a negative electrode connection portion defined on the negative electrode substrate where the negative electrode mixture layer is not formed at one end of the electrode body in a widthwise direction. The positive electrode plate includes a positive electrode substrate formed by a strip of a metal foil having a uniform width, a positive electrode mixture layer formed on each of two opposite surfaces of the positive electrode substrate, a positive electrode connection portion defined on the positive electrode substrate where the positive electrode mixture layer is not formed at an other end of the electrode body in the widthwise direction, and an insulating protective layer arranged on each of two opposite surfaces of the positive electrode connection portion. The insulative protective layer is adjacent to the positive electrode mixture layer and facing the negative electrode mixture layer. The non-aqueous electrolyte rechargeable battery further includes a negative electrode current collector bonded to the negative electrode connection portion at where opposing parts of the negative electrode connection portion are joined to one another at the one end of the electrode body in the widthwise direction, and a positive electrode current collector bonded to the positive electrode current collector at where opposing parts of the positive electrode connection portion are joined to one another at the other end of the electrode body in the widthwise direction. In a state in which the positive electrode mixture layer is fixed, a tip of a needle is pressed against the insulating protective layer at a contact point where the tip of the needle contacting the insulating protective layer is located at a distance L (mm) from a boundary between where the positive electrode mixture layer is formed and where the positive electrode mixture is not formed to measure a response load F (N) and a displacement amount S (mm). The response load F (N) that is measured when a correlation of the response load F (N) and the displacement amount S (mm) is broken corresponds to a yield stress X (N). A flexural strength M (N) is obtained by calculating “M (N)=FL/S”. In the insulating protective layer formed on each of the two opposite surfaces of the positive electrode connection portion, X (N) represents the yield stress (N) of the positive electrode plate, and M_{IN} (N) represents the flexural strength of the positive electrode plate including only an inner insulating protective layer formed on a surface of the positive electrode connection portion that is located toward the positive electrode current collector in a stacking direction of the electrode body. The yield stress X (N) and the flexural strength M_{IN} (N) of the positive electrode plate are set such that the positive electrode connection portion, where the opposing parts are joined to one another and bonded to the positive electrode current collector, is bent at an end of the negative electrode mixture layer, formed on a surface of the negative electrode substrate that is located away from the positive electrode current collector in the stacking direction of the electrode body, with the separator located in between. In the non-aqueous electrolyte rechargeable battery, when M_{OUT} (N) represents the flexural strength (N) of the positive electrode plate including only an outer insulating protective layer formed on a surface of the positive electrode connection portion that is located away from the positive electrode current collector in the stacking direction of the electrode body, in the positive electrode connection portion where the opposing parts are joined to one another and bonded to the positive electrode current collector, the flexural strength M_{OUT} (N) may be set to restrict bending of the positive electrode plate such that the outer insulating protective layer, formed on a surface of the positive electrode connection portion that is located away from the positive electrode current collector in the stacking direction of the electrode body, does not contact the separator.

Other features and aspects will be apparent from the following detailed description, the drawings, and the claims.

### BRIEF DESCRIPTION OF THE DRAWING

FIG. 1 is a perspective view showing a battery cell of a lithium-ion rechargeable battery.

FIG. 2 is a diagram schematically showing the structure of an electrode body in an unrolled state.

FIG. 3 is a perspective view showing an end of the electrode body in a widthwise direction.

FIG. 4 is a schematic diagram showing the structure of the electrode body of the lithium-ion rechargeable battery.

FIG. 5A is a schematic diagram showing a cross section of an electrode body of a typical lithium-ion rechargeable battery taken along line A-A in FIG. 3, in which a negative electrode plate, a positive electrode plate, and separators are stacked in a step of manufacturing the electrode body. FIG. 5B is a schematic diagram showing a cross section of the electrode body of the typical lithium-ion rechargeable battery taken along line A-A in FIG. 3, in which opposing parts of a negative electrode connection portion and opposing parts of a positive electrode connection portion are respectively joined together and welded to a negative electrode current collector and a positive electrode current collector in a step of manufacturing the electrode body.

FIG. 6 is a schematic diagram showing a pressurizing test device that performs measurement.

FIG. 7 is a schematic diagram showing a foil-joining start position of a positive electrode connection portion in the present embodiment.

FIG. 8 is a schematic diagram showing a foil-joining start position of a positive electrode connection portion in a known art.

FIG. 9 is a schematic diagram showing a foil-joining start position of a positive electrode connection portion in another known art.

FIG. 10 is a schematic diagram showing a cross section of the electrode body taken along the widthwise direction in a state in which opposing parts of the positive electrode connection portion are joined together and welded to a positive electrode current collector, and pressure is applied to bind the lithium-ion rechargeable battery in a battery stack and compress the entire electrode body in a thickness direction.

FIG. 11 is a schematic diagram showing contact between an outer insulating protective layer and a separator in a known art.

FIG. 12 is a perspective view showing a coater of an insulating protective layer.

FIG. 13 is a table showing results of experimental examples.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

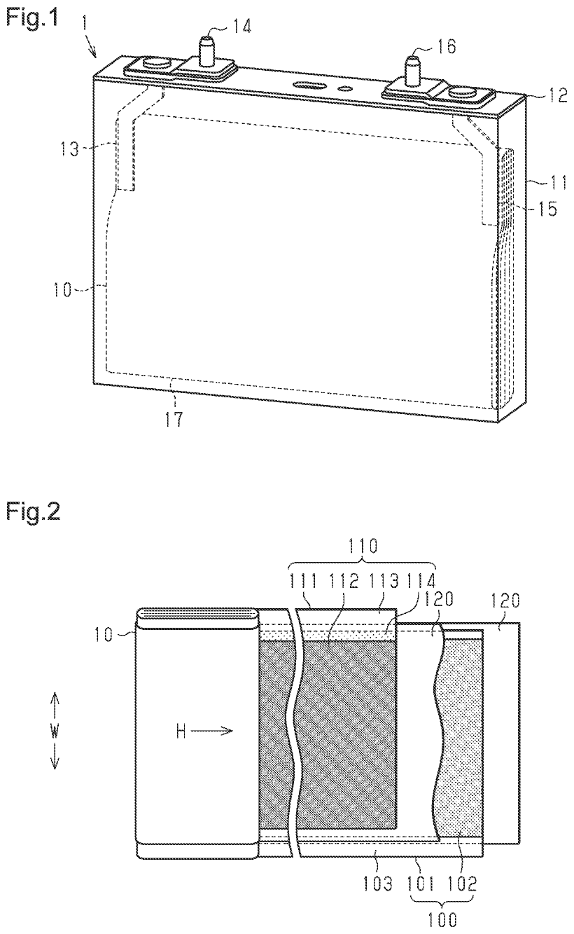

An embodiment of a lithium-ion rechargeable battery 1, which is an example of a non-aqueous electrolyte rechargeable battery, will now be described with reference to FIGS. 1 to 13.

### Features of Present Embodiment

An objective of the lithium-ion rechargeable battery 1 in accordance with the present embodiment is to reduce a load applied to a positive electrode substrate 111, a positive electrode mixture layer 112, a separator 120, and the like when, for example, joining opposing parts of a positive electrode connection portion 113 or performing a compression step. Accordingly, the lithium-ion rechargeable battery 1 of the present embodiment has the following characteristics and operation.

### Background Art of Present Embodiment

The structure of an electrode body 10, serving as a background art of the present embodiment, will be described below.

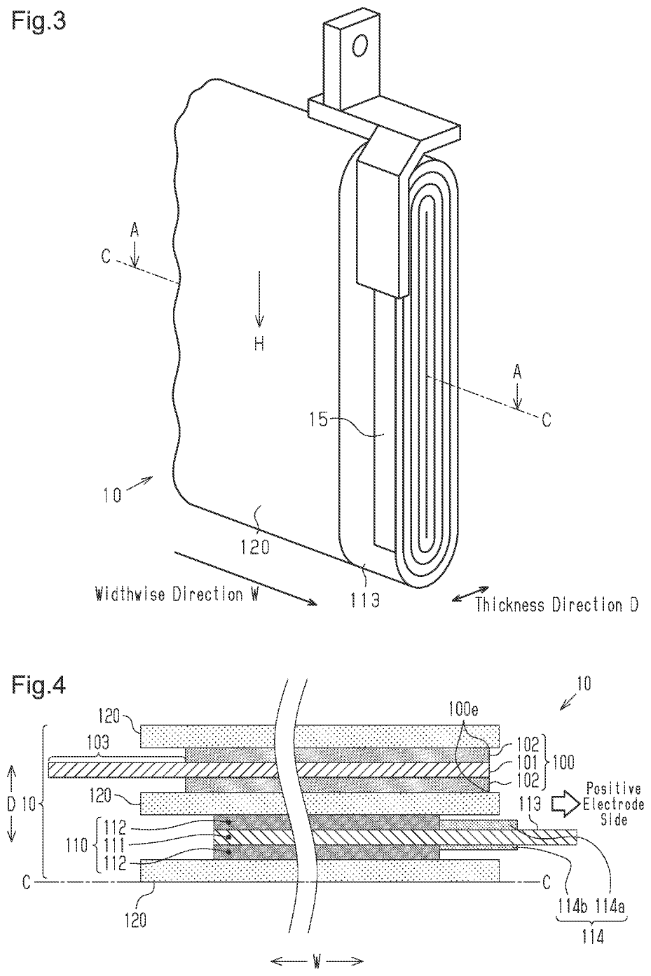

FIG. 2 is a schematic diagram showing the structure of a rolled-type electrode body 10 in a partially unrolled state. The electrode body 10 is formed by stacking a negative electrode plate 100, a positive electrode plate 110, and separators 120, and then rolling the stack. FIG. 3 is a perspective view showing an end of the rolled-type electrode body 10 in a widthwise direction W. The entire rolled-type electrode body 10 is flattened and has the form of a stadium track as viewed in the widthwise direction W.

FIG. 4 is a schematic diagram showing the structure of the electrode body 10 of the lithium-ion rechargeable battery 1.

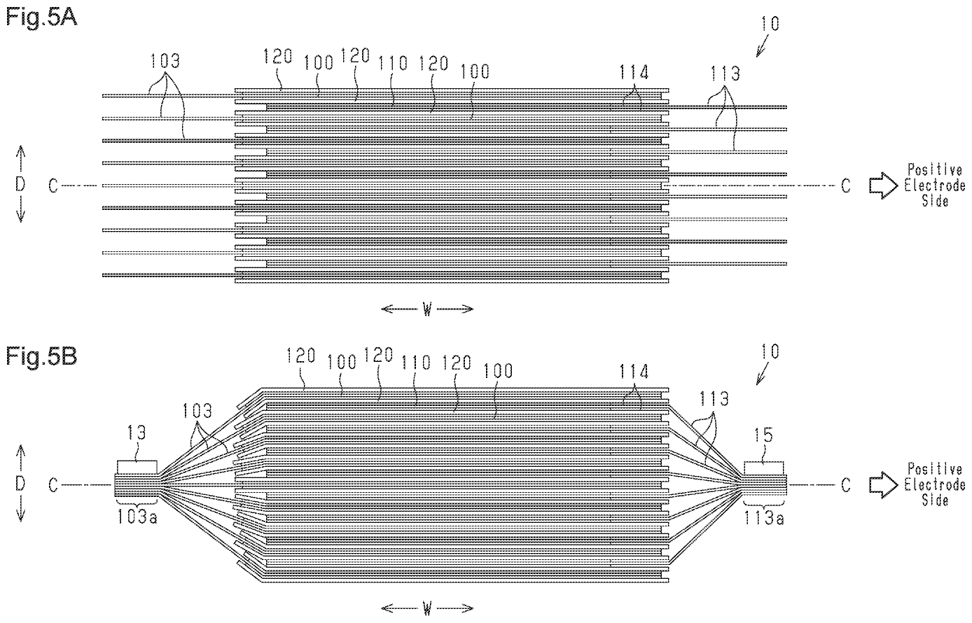

FIG. 5A is a schematic diagram showing a cross section of an electrode body 10 of such typical rolled-type lithium-ion rechargeable battery 1 taken along line A-A in FIG. 3. In a step of manufacturing the electrode body 10, a negative electrode plate 100, a positive electrode plate 110, and separators 120 are stacked. When the negative electrode plate 100 and the positive electrode plate 110 are stacked as shown in FIG. 5A, the negative electrode plate 100 and the positive electrode plate 110 are shifted from each other in the widthwise direction W as shown in FIG. 4. In the electrode body 10 including the rolled stack, a negative electrode connection portion 103 is also rolled such that overlapping parts of the negative electrode connection portion 103 face each other in a thickness direction of the electrode body 10. In other words, the negative electrode connection portion 103 of the electrode body 10 includes laminated negative electrode connection portions 103 (negative electrode connection portion stack) overlapping one another in the thickness direction of the electrode body 10. As a result, the laminated negative electrode connection portions 103 (negative electrode connection portion stack), where a negative electrode mixture layer 102 is not formed and the metal foil is exposed, project out of one end (left side in drawing) of the electrode body 10 in the widthwise direction W. Further, in the electrode body 10 including the rolled stack, a positive electrode connection portion 113 is also rolled such that overlapping parts of the positive electrode connection portion 113 face each other in the thickness direction of the electrode body 10. In other words, the positive electrode connection portion 113 of the electrode body 10 includes laminated positive electrode connection portions 113 (positive electrode connection portion stack) overlapping one another in the thickness direction of the electrode body 10. Thus, the laminated positive electrode connection portions 113 (positive electrode connection portion stack), where a positive electrode mixture layer 112 is not formed, project out of the other end (right side in drawing) of the electrode body 10 in the widthwise direction W. An insulating protective layer 114 is formed on the positive electrode connection portion 113 such that the insulating protective layer 114 is adjacent to the positive electrode mixture layer 112 and facing the negative electrode mixture layer 102 with the separator 120 located in between. As shown in FIG. 4, the insulating protective layer 114 includes an outer insulating protective layer 114a and an inner insulating protective layer 114b. The outer insulating protective layer 114a and the inner insulating protective layer 114b may be collectively referred to as the insulating protective layer 114. In the prior art, the distal end parts of the negative electrode plate 100 extending out of the stack and arranged one over another form a negative electrode connection portion 103 (laminated negative electrode connection portions) such that the distal end parts are located at the same position in the widthwise direction W, and the distal end parts of the positive electrode plate 110 extending out of the stack and arranged one over another form a positive electrode connection portion 113 (laminated positive electrode connection portions) such that the distal end parts are located at the same position in the widthwise direction W.

FIG. 5B is a schematic diagram showing a cross section of the electrode body 10 of the typical lithium-ion rechargeable battery 1 taken along line A-A in FIG. 3. In a step of manufacturing the electrode body 10, opposing parts of the negative electrode connection portion 103 are joined together and welded to a negative electrode current collector 13, and opposing parts of the positive electrode connection portion 113 are joined together and welded to a positive electrode current collector 15. As shown in FIG. 5B, the distal end parts of the negative electrode connection portion 103 (laminated negative electrode connection portions) are compressed and joined with one another in a thickness direction D, and the distal ends of the positive electrode connection portion 113 (laminated positive electrode connection portions) are compressed and joined to one another in the thickness direction D. The joined negative electrode connection portion 103 is welded in a state held between two negative electrode current collectors 13. As shown in FIG. 3, the joined positive electrode connection portion 113 are welded in a state held between two positive electrode current collectors 15. As shown in FIG. 1, the negative electrode current collector 13 extends through a lid 12 to the outside of a battery case 11 and is connected to a negative electrode external terminal 14 outside the lithium-ion rechargeable battery 1. The positive electrode current collector 15 extends through the lid 12 to the outside of the battery case 11 and is connected to a positive electrode external terminal 16 outside the lithium-ion rechargeable battery 1.

As shown in FIG. 4, the negative electrode plate 100 includes a negative electrode mixture layer 102 formed on each of two opposite surfaces of a negative electrode substrate 101. The negative electrode substrate 101 is formed by a strip of a Cu foil having a uniform width. The negative electrode connection portion 103, where the negative electrode mixture layer 102 is not formed and the negative electrode substrate 101 is exposed, extends on the negative electrode mixture layer 102 at one end (left end in drawing) of the electrode body 10 in the one-end direction.

The positive electrode plate 110 is arranged on the negative electrode plate 100 with the separator 120 located in between. The positive electrode plate 110 includes a positive electrode mixture layer 112 formed on each of two opposite surfaces of a positive electrode substrate 111. The positive electrode substrate 111 is formed by a strip of an Al foil having a uniform width. The positive electrode connection portion 113, where the positive electrode mixture layer 112 is not formed and the positive electrode substrate 111 is exposed, extends on the positive electrode mixture layer 112 at the other end (right end in drawing) of the electrode body 10 in the other-end direction. The positive electrode mixture layer 112 is shorter than a length between two ends of the negative electrode mixture layer 102 in the widthwise direction W, and is thus formed in a range within the two ends of the negative electrode mixture layer 102. Accordingly, part of the positive electrode connection portion 113, where the Al foil is exposed, faces the negative electrode mixture layer 102 via the separator 120. Thus, in the lithium-ion rechargeable battery 1 of the present embodiment, the insulating protective layer 114 is arranged on each of two opposite surfaces of the positive electrode connection portion 113 such that the insulating protective layer 114 is adjacent to the positive electrode mixture layer 112 and facing the negative electrode mixture layer 102.

Of the insulating protective layers 114 formed on the opposite surfaces of the positive electrode connection portion 113, the outer insulating protective layer 114a refers to the insulating protective layer 114 formed on a surface of the positive electrode substrate 111 that is located away from the positive electrode current collector 15 in a stacking direction (thickness direction) of the electrode body 10. Further, the inner insulating protective layer 114b refers to the insulating protective layer 114 formed on a surface of the positive electrode substrate 111 that is located toward the positive electrode current collector 15 in the stacking direction (thickness direction) of the electrode body 10.

### Characteristic Structure of Present Embodiment

The positive electrode plate 110 of the lithium-ion rechargeable battery 1 in the present embodiment is characterized in that a yield stress X (N) of the insulating protective layer 114 applied to a portion of the positive electrode substrate 111 where the positive electrode mixture layer 112 is not formed, a flexural strength M_{IN} (N) of the inner insulating protective layer 114b, and a flexural strength M_{OUT} (N) of the outer insulating protective layer 114a are in the following ranges.

### Flexural Strengths M_{IN} (N) and M_{OUT} (N)

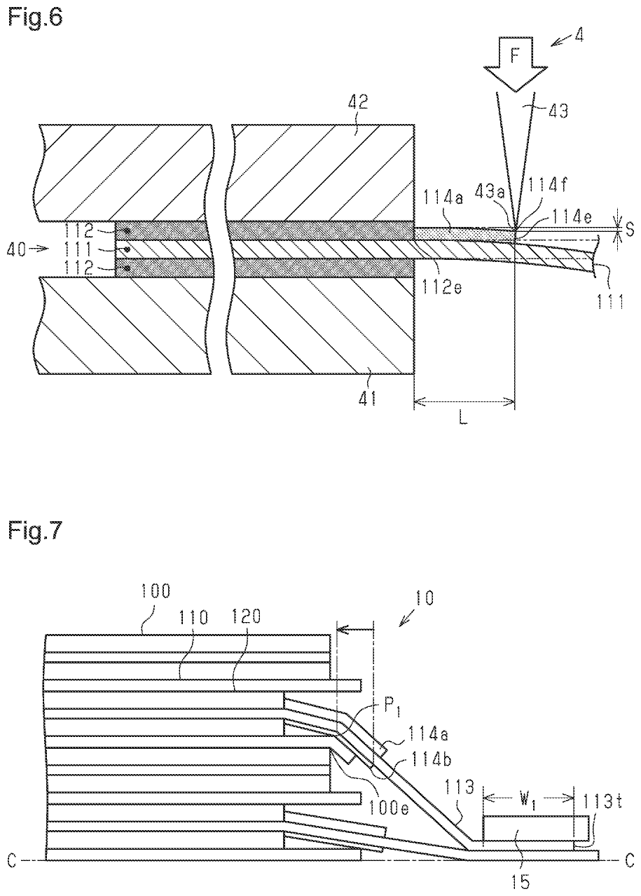

FIG. 6 is a schematic diagram showing a pressurizing test device 4 that performs measurement.

In the present application, the flexural strength M (N) of the insulating protective layer 114 is defined as follows. First, the measurement method is described. A strip of a test piece 40 having a length of 50 mm is prepared from the positive electrode plate 110 in a direction (direction W) orthogonal to a direction in which the positive electrode mixture layer 112 is applied. In order to perform accurate measurement on both the outer insulating protective layer 114a and the inner insulating protective layer 114b, the positive electrode connection portion 113 used in the test shown in FIG. 6 includes only the outer insulating protective layer 114a, which is measured. In this case, the inner insulating protective layer 114b, which is not measured, is absent.

Although not shown in the drawing, measurement is also performed on a test piece 40 that includes only the inner insulating protective layer 114b, which is measured, and does not include the outer insulating protective layer 114a, which is not measured.

The test piece 40 set on a stage 41 of the pressurizing test device 4 is fixed with a weight 42 up to an end 112e, serving as the boundary between where the positive electrode mixture layer 112 is formed and where the positive electrode mixture layer 112 is not formed, such that the outer insulating protective layer 114a projects outward over a distance L (mm) or greater (L=3 mm in present embodiment). In this state, a tip 43a of a probe 43 of the pressurizing test device 4 is pressed against a measurement point 114f to measure a displacement amount S (mm) and a response load F (N). The measurement point 114f is separated from the end 112e by the distance L (L=3 mm) and is located near an insulating protective layer end 114e of the outer insulating protective layer 114a.

The pressurizing test device 4 used for the measurement obtains a relationship of the displacement amount S (mm) and the response load F (N). The pressurizing test device 4 (refer to FIG. 6) is, for example, the AGX-V series of the precision universal testing machine AUTOGRAPH (registered trademark of Shimadzu Corporation). The pressurizing test device 4 (not entirely shown in drawing) measures the response load F (N) and the displacement amount S (mm) by compressing the test piece 40 with pressure applied from above in the thickness direction D to the measurement point 114f located near the insulating protective layer end 114e of the insulating protective layer 114. The displacement amount S (mm), which corresponds to a distance over which the measurement point 114f is displaced by the pressure, is set to increase at a constant rate as time (s) elapses. Further, the elapsed time (s) and the response load F (N) are sequentially (e.g., every one second) stored in a controller (not shown) of the pressurizing test device 4.

Preferably, the tip 43a of the probe 43 of the pressurizing test device 4 has the form of a needle. In the present embodiment, the probe 43 is semispherical and has a tip in which “R=0.1 μm” is satisfied. A microscope (not shown) or the like may be used to measure the displacement amount S (mm) between the end 112e at the mixture application boundary and the measurement point 114f in contact with the tip 43a of the probe 43.

With such a measurement method, “flexural strength M (N)=response load F (N)× distance L (mm)/displacement amount S (mm)” is calculated. Thus, the unit of the flexural strength M is “N”. The calculation of the flexural strength M (N) uses values in a region in which the displacement amount S (mm) and the response load F (N) have a linear correlation.

As described above, the flexural strength M_{IN} (N) of the inner insulating protective layer 114b and the flexural strength M_{OUT} (N) of the outer insulating protective layer 114a are each measured by bending the insulating layer, formed on only one side of the positive electrode connection portion 113, in a direction (downward) opposite to the direction in which the insulating layer is applied. The flexural strength M_{IN} (N) is also measured in the same manner as the flexural strength M_{OUT} (N).

### Yield Stress X (N)

The insulating protective layer 114 includes the outer insulating protective layer 114a and the inner insulating protective layer 114b that are respectively formed on the two opposite surfaces of the positive electrode substrate 111 (positive electrode connection portion 113). The yield stress of such positive electrode plate 110 is referred to as X (N).

In the present embodiment, the yield stress X (N) is measured in a manner fundamentally the same as the flexural strength M (N). The positive electrode mixture layer 112 of a test piece 40, including the outer insulating protective layer 114a and the inner insulating protective layer 114b respectively formed on the opposite surfaces of the positive electrode substrate 111, is fixed to the pressurizing test device 4 shown in FIG. 6. In this state, the tip 43a of the needle of the probe 43 is pressed against the contact point located at the distance L (mm) (here, 3 mm) from the end 112e at the boundary between where the positive electrode mixture layer 112 is formed and where the positive electrode mixture layer 112 is not formed, as the measurement point 114f. In other words, in a state in which the test piece 40 is fixed to the pressurizing test device 4, the needle tip 43a of the probe 43 is pressed against the contact point located on the outer insulating protective layer 114a at the distance L (mm) from the end 112e of the positive electrode mixture layer 112, as the measurement point 114f. The response load F (N) and the displacement amount S (mm) are measured when the needle tip 43a is pressed against the outer insulating protective layer 114a. In this case, the response load F (N) and the displacement amount S (mm) have a positive correlation during a period in which the positive electrode plate 110, including the outer insulating protective layer 114a and the inner insulating protective layer 114b, is elastically deformed. As the response load F (N) increases, the positive electrode plate 110 undergoes plastic deformation. This may break the positive correlation of the response load F (N) and the displacement amount S (mm). In other words, the yield stress X (N) corresponds to the response load F (N) at an inflection point of a linear graph illustrating the relationship of the response load F (N) and the displacement amount S (mm). In actuality, the positive correlation of the response load F (N) and the displacement amount S (mm) contains errors and variations. Thus, a certain tolerable range is given to the reference used in the determination. In the present embodiment, the yield stress X (N) corresponds to the response load F (N) when the positive correlation of the response load F (N) and the displacement amount S (mm) is broken.

Setting of Yield Stress X (N) and Flexural Strengths M_{IN} (N) and M_{OUT}(N)

The present embodiment is characterized in that the yield stress satisfies “X≤ 0.122 N”, the flexural strength satisfies “M_{IN}≥0.0372 N”, and the flexural strength satisfies “M_{OUT}≥ 0.0343 N”.

The reasoning for such settings will now be described.

The yield stress X (N) and the inner flexural strength M_{IN} (N) are set such that the opposing parts of the positive electrode connection portion 113, joined with one another and welded to the positive electrode current collector 15, are bent at a negative electrode slit end 100e. The negative electrode slit end 100e is an end of the negative electrode mixture layer 102 formed on a surface of the negative electrode substrate 101 that is located away from the positive electrode current collector 15 in the thickness direction D (stacking direction) of the electrode body 10 with the separator 120 in between.

Further, in the positive electrode connection portion 113 where the opposing parts are joined together and welded to the positive electrode current collector 15, the flexural strength M_{OUT} (N) of the outer insulating protective layer 114a is set such that the outer insulating protective layer 114a formed on a surface of the positive electrode connection portion 113 that is located away from the positive electrode current collector 15 in the thickness direction D of the electrode body 10 does not contact the separator 120.

The structure of the lithium-ion rechargeable battery 1 in accordance with the present embodiment having the above-described characteristics will now be described in detail.

### Basic Structure of Lithium-Ion Rechargeable Battery 1

FIG. 1 is a perspective view of the lithium-ion rechargeable battery 1. As shown in FIG. 1, the lithium-ion rechargeable battery 1 is structured as a battery cell. The lithium-ion rechargeable battery 1 includes the box-shaped battery case 11 having an opening in the upper side. The battery case 11 includes the lid 12 that seals the battery case 11. The battery case 11 accommodates the electrode body 10. A non-aqueous electrolyte solution 17 is injected into the battery case 11 through an injection hole (not shown). The battery case 11 and the lid 12 are formed from a metal such as an aluminum alloy. The lithium-ion rechargeable battery 1 forms a sealed battery container by attaching the lid 12 to the battery case 11. Further, the lithium-ion rechargeable battery 1 includes a negative electrode external terminal 14 and a positive electrode external terminal 16 on the lid 12. The negative electrode external terminal 14 and the positive electrode external terminal 16 are used for charging and discharging of the lithium-ion rechargeable battery 1.

### Electrode Body 10

FIG. 2 is a schematic diagram showing the structure of the rolled-type electrode body 10. The electrode body 10 is formed by stacking the negative electrode plate 100, the positive electrode plate 110, and the separator 120 arranged in between, and rolling the stack into a flat roll. The negative electrode plate 100 includes the negative electrode mixture layer 102 formed on the negative electrode substrate 101. The negative electrode connection portion 103 is defined at one end of the electrode body 10 in the widthwise direction W (rolling-axis direction) that is orthogonal to a rolling direction (rolling direction H). The negative electrode mixture layer 102 is not formed on the negative electrode connection portion 103 such that the negative electrode substrate 101 is exposed. The positive electrode plate 110 includes the positive electrode mixture layer 112 formed on the positive electrode substrate 111. The positive electrode connection portion 113 is defined at the other end of the electrode body 10 in the widthwise direction W (rolling-axis direction) that is orthogonal to the direction in which the positive electrode substrate 111 is rolled (rolling direction H). The positive electrode mixture layer 112 is not formed on the positive electrode connection portion 113 such that the positive electrode substrate 111 is exposed.

### Structure of End Portion of Electrode Body 10

FIG. 3 is a perspective view showing an end of the rolled-type electrode body 10 in the widthwise direction. The negative electrode plate 100, the positive electrode plate 110, and the separators 120 are rolled to form such flat electrode body 10 having the form of a stadium track as viewed in the widthwise direction W. The electrode body 10 is semicircular at the upper and lower ends where the negative electrode plate 100 and the positive electrode plate 110 form curved portions. Further, the electrode body 10 is linear at the central portion where the negative electrode plate 100 and the positive electrode plate 110 form a flat portion. In the present embodiment, a hypothetical straight line located at a portion corresponding to the rolling axis is referred to as “the center C-C”.

At the other end (right end in drawing) of the electrode body 10 in the widthwise direction W shown in FIG. 3, the opposing parts of the positive electrode connection portion 113 at the flat portion are joined to one another and welded to the positive electrode current collector 15 so that the positive electrode connection portion 113 is electrically and mechanically fixed to the positive electrode current collector 15. The electrode body 10 shown in FIG. 3 is merely an example, and its shape may be changed.

### Stack Forming Electrode Body 10

FIG. 4 is a schematic diagram showing the structure of a stack forming the electrode body 10 of the lithium-ion rechargeable battery 1. As shown in FIG. 4, the electrode body 10 of the lithium-ion rechargeable battery 1 includes the negative electrode plate 100, the positive electrode plate 110, and the separators 120. The negative electrode plate 100 includes the negative electrode mixture layer 102 on two opposite surfaces of the negative electrode substrate 101. The positive electrode plate 110 includes the positive electrode mixture layer 112 on two opposite surfaces of the positive electrode substrate 111. The negative electrode plate 100, the positive electrode plate 110, and the separators 120 are stacked to form the stack. The stack is rolled about in its longitudinal direction about the rolling axis and shaped into the flat electrode body 10.

### Negative Electrode Plate 100

As shown in FIG. 4, the negative electrode plate 100 includes the negative electrode mixture layer 102 formed on the two opposite surfaces of the negative electrode substrate 101. In the embodiment, the negative electrode substrate 101 is formed by a Cu foil. The negative electrode substrate 101 acts as the body and the base for the negative electrode mixture layer 102. Also, the negative electrode substrate 101 has a functionality of a current collecting member that collects electricity from the negative electrode mixture layer 102. In the negative electrode plate 100, the negative electrode mixture layer 102 is formed on the metal negative electrode substrate 101. The negative electrode mixture layer 102 includes a negative electrode active material. In the embodiment, the negative electrode active material is a material capable of storing and releasing lithium ions, and includes powders of a carbon material such as graphite or the like.

The negative electrode plate 100 is manufactured by, for example, kneading the negative electrode active material, a solvent, and a binder, applying the kneaded negative electrode mixture to the negative electrode substrate 101, and drying the negative electrode mixture.

### Positive Electrode Plate 110

As shown in FIG. 4, the positive electrode plate 110 includes the positive electrode mixture layer 112 formed on the two opposite surfaces of the positive electrode substrate 111. In the present embodiment, the positive electrode substrate 111 is formed by an Al foil or an Al alloy foil. The positive electrode substrate 111 acts as the body and the base for the positive electrode mixture layer 112. Also, the positive electrode substrate 111 has a functionality of a current collecting member that collects electricity from the positive electrode mixture layer 112.

In the positive electrode plate 110, the positive electrode mixture layer 112 is formed on the two opposite surfaces of the positive electrode substrate 111. The positive electrode mixture layer 112 includes a positive electrode active material. The positive electrode active material is a material capable of storing and releasing lithium, and may include lithium cobalt oxide (LiCoO₂), lithium manganese oxide (LiMn₂O₄), lithium nickel oxide (LiNiO₂), or the like. Alternatively, the positive electrode active material may include a material in which LiCoO₂, LiMn₂O₄, and LiNiO₂, are mixed in any proportion.

The positive electrode mixture layer 112 further includes a conductive material. Examples of the conductive material include graphite and carbon black such as acetylene black (AB), ketjen black, and the like.

The positive electrode plate 110 is manufactured by, for example, kneading the positive electrode active material, the conductive material, a solvent, and a binder, applying the kneaded positive electrode mixture to the positive electrode substrate 111, and drying the positive electrode mixture.

### Separator 120

The separator 120 is a nonwoven fabric of polypropylene and the like that holds the non-aqueous electrolyte solution 17 between the negative electrode plate 100 and the positive electrode plate 110. Further, the separator 120 may be any one of or a combination of a porous polymer film, such as a porous polyethylene film, a porous polyolefin film, or a porous polyvinyl chloride film, and a lithium ion or ion conductive polymer electrolyte film. When the electrode body 10 is immersed in the non-aqueous electrolyte solution 17, the non-aqueous electrolyte solution 17 permeates the separator 120 from the ends toward the center.

### Insulating Protective Layer 114

The positive electrode plate 110 of the lithium-ion rechargeable battery 1 in the present embodiment has the following characteristics in the insulating protective layer 114 applied to a portion of the positive electrode substrate 111 where the positive electrode mixture layer 112 is not formed. The positive electrode plate 110 including the insulating protective layer 114 has the yield stress X (N) that satisfies “X≤1222 N”. The flexural strength M_{IN} (N) of the inner insulating protective layer 114b satisfies “M_{IN}≥0.0372 N”. The flexural strength M_{OUT} (N) of the outer insulating protective layer 114a satisfies “M_{OUT}≥0.0343 N”.

Such difference in strength can be obtained by adjusting the composition, viscosity, solid content ratio NV, and the like of an insulating protective paste. Also, such difference in strength can be obtained by adjusting the thickness of the insulating protective layer with a discharge amount and a discharge speed of a coater 5, a conveying speed of the positive electrode substrate 111, and the like. For example, when the ratio of insulator particles is relatively large, the insulating protective layer becomes difficult to bend, thereby increasing the flexural strength M (N).

### Composition of Insulating Protective Layer 114

In the insulating protective layer 114 of the present embodiment, insulator particles are fixed by a binder in a dispersed state. The insulating protective layer 114 is formed by applying an insulating protective paste to the surface of the positive electrode substrate 111 along the end of the positive electrode mixture layer 112 and drying the applied insulating protective paste.

The insulating protective paste is a paste obtained by dispersing insulator particles in a liquid in which a solvent is added to a binder. Further, a dispersant is added so that the insulator particles are evenly dispersed in the paste.

The insulator particles are disposed between the negative electrode mixture layer 102 and the positive electrode substrate 111 (positive electrode connection portion 113) to obtain electrical insulation thereof. Examples of the insulator particles include ceramics obtained by firing a metal oxide having high insulating properties and hardness that prevents entry of foreign matter. Specifically, the insulator particles include particles of boehmite, alumina, or the like. In the present embodiment, the insulator particles include boehmite.

### Boehmite

Boehmite is an aluminum hydroxide (γ-AlO(OH)) mineral, and is a component of aluminum ore (bauxite). Boehmite exhibits a glassy to pearly luster, and has a Mohs hardness of 3 to 3.5 and a specific gravity of 3.00 to 3.07. Boehmite has high insulating properties, heat resistance and hardness. Industrially, boehmite may be used as an inexpensive flame-retardant additive for fire-resistant polymers.

Boehmite is represented by a chemical composition of AlO(OH) or Al₂O₃·H₂O, and is a chemically stable alumina monohydrate that is typically produced by performing a heating treatment or a hydrothermal treatment on alumina trihydrate in air. Boehmite has a high dehydration temperature of 450 to 530° C., and its shape can be controlled into various forms, such as plate-like, needle-like, and hexagonal plate-like, by adjusting production conditions. Further, the aspect ratio and the particle diameter of boehmite can be controlled by adjusting the production conditions.

Examples of the binder include polyvinylidene fluoride (PVdF), polytetrafluoroethylene (PTFE), polyacrylic acid, and polyacrylate. In the present embodiment, the binder is polyvinylidene fluoride (PVdF).

### Mixing of Insulator Particles and Binder

In the present embodiment, the insulating protective layer 114 is formed from insulator particles including boehmite and a binder including PVdF. The mass ratio of boehmite:PVdF is in a range of 70:30 to 90:10.

### Non-Aqueous Electrolyte Solution 17

The non-aqueous electrolyte solution 17 shown in FIG. 1 is a composition containing a supporting electrolyte in a non-aqueous solvent. The non-aqueous solvent may be ethylene carbonate (EC). Alternatively, the non-aqueous solvent may be one or two or more selected from a group consisting of propylene carbonate (PC), diethyl carbonate (DEC), dimethyl carbonate (DMC), ethyl methyl carbonate (EMC), and the like. The support electrolyte may be a lithium compound (lithium salt) of one or two or more selected from a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

### Method for Applying Insulating Protective Layer 114

An example of a method for applying the insulating protective layer 114 in the present embodiment will now be described. In the present embodiment, the positive electrode plate 110 of the lithium-ion rechargeable battery 1 is characterized in that the insulating protective layer 114, applied to a portion of the positive electrode substrate 111 where the positive electrode mixture layer 112 is not formed, has the yield stress X (N) and the flexural strengths M_{IN}(N) and M_{OUT} (N) that are in the predetermined ranges. Such differences can be obtained by adjusting the composition, viscosity, and solid content ratio NV of the insulating protective paste. Also, such differences can be achieved by adjusting the thickness of the insulating protective layer with a discharge amount and a discharge speed of the coater 5, a conveying speed of the positive electrode substrate 111, and the like. These methods may be performed in combination to obtain appropriate yield stress X (N) and the flexural strengths M_{IN} (N) and M_{OUT} (N).

### Structure of Coater 5

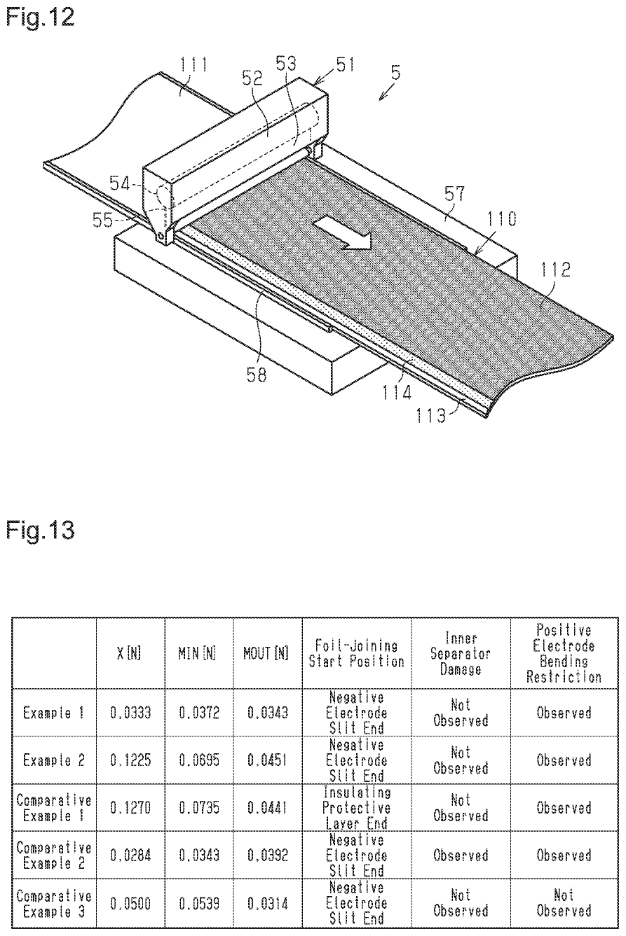

FIG. 12 is a perspective view showing the coater 5 in a coating step of the present embodiment. As shown in FIG. 12, the coater 5 includes a stage 57 acting as a base. The stage 57 includes a positioning guide 58 used for conveying an uncut positive electrode substrate 111, which is a long strip of an Al foil. The positive electrode substrate 111 is drawn from a supply reel (not shown) and conveyed on the stage 57 by a conveying means. A gate-shaped die nozzle 51 is arranged at an upstream end of the stage 57 in a direction in which the positive electrode substrate 111 is conveyed. The die nozzle 51 extends across the positive electrode substrate 111 in a direction orthogonal to the conveying direction. The die nozzle 51 includes a first die 52 that stores a positive electrode mixture paste. The first die 52 is a compartment arranged at a position corresponding to where the positive electrode mixture layer 112 is formed. The first die 52 stores the positive electrode mixture paste that has been supplied by a supplying means (not shown). Further, the die nozzle 51 includes a second die 54. The second die 54 is a compartment arranged at a position corresponding to where the insulating protective layer 114 is formed. The second die 54 stores the insulating protective paste that has been supplied by a supplying means (not shown). The first die 52 and the second die 54 are aligned along a straight line.

A first nozzle 53 extends from a lower part of the first die 52 to where the positive electrode mixture layer 112 of the positive electrode substrate 111 is formed on the stage 57. When the internal pressure of the first die 52 is increased by a pressurizing means (not shown), a predetermined amount of the positive electrode mixture paste is discharged from the first nozzle 53 to where the positive electrode mixture layer 112 of the positive electrode substrate 111 is formed.

A second nozzle 55 extends from a lower part of the second die 54 to where the insulating protective layer 114 of the positive electrode substrate 111 is formed on the stage 57. When the internal pressure of the second die 54 is increased by a pressurizing means (not shown), a predetermined amount of the insulating protective paste is discharged from the second nozzle 55 to where the insulating protective layer 114 of the positive electrode substrate 111 is formed. In this manner, the positive electrode mixture layer 112 and the inner insulating protective layer 114b are formed on the inner side of the positive electrode substrate 111.

Next, the positive electrode mixture layer 112 and the outer insulating protective layer 114a are formed on the outer side of the positive electrode substrate 111.

The coating step is not limited to the above method of simultaneous coating. Instead, the positive electrode mixture layer 112 and the insulating protective layer 114 may be formed separately.

### Operation of Present Embodiment

Operation of the present embodiment will now be described. In the present embodiment, the portion of the positive electrode plate 110 corresponding to the insulating protective layer 114 is set such that “yield stress X≤0.122 N” is satisfied as a first condition. Further, the inner insulating protective layer 114b is set such that “flexural strength M_{IN}≥0.0372 N” is satisfied as a second condition. Furthermore, the outer insulating protective layer 114a is set such that “flexural strength M_{OUT}≥ 0.0343 N” is satisfied as a third condition. Thus, the present embodiment has the following operation.

### First Condition (Yield Stress X≤0.122 N)

When the portion of the positive electrode plate 110 corresponding to the insulating protective layer 114 is set such that “yield stress X≤0.122 N” is satisfied, the positive electrode connection portion 113 held between the insulating protective layers 114 becomes easily bent.

A position at which the positive electrode connection portion 113 is bent toward the positive electrode current collector 15 will be referred to as “the foil-joining start position P₁”.

### Foil-Joining State of Typical Positive Electrode Connection Portion 113

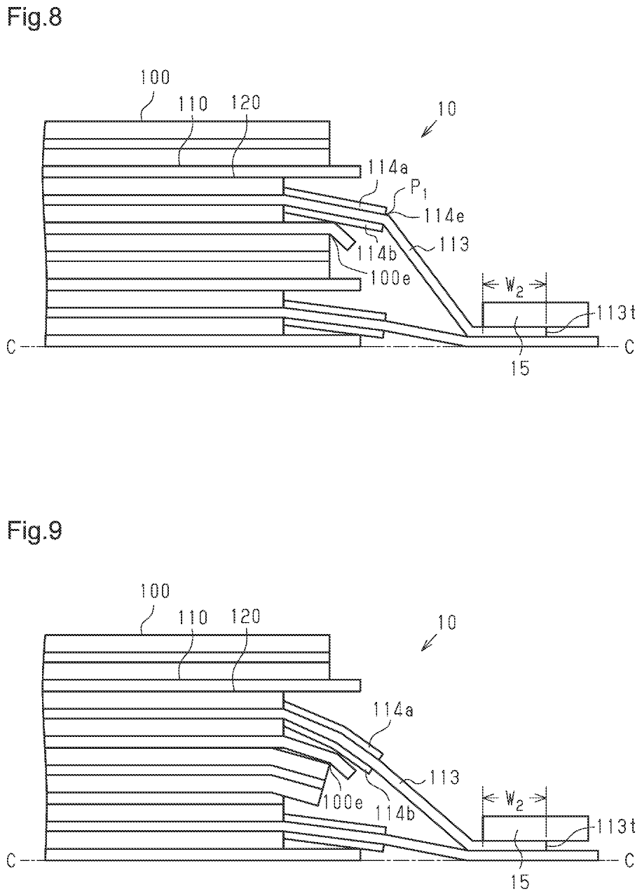

FIG. 8 is a schematic diagram showing the foil-joining start position P₁ of a conventional positive electrode connection portion 113. FIG. 8 conceptually illustrates the invention and does not show the left side and the section below the center C-C shown in FIG. 5B. Only a few staked layers are shown. The same applies to FIGS. 7 to 10.

The portion of the positive electrode plate 110 corresponding to the insulating protective layer 114 of the known art shown in FIG. 8 has a relatively large yield stress X (N). The flexural strength M_{OUT} (N) of the outer insulating protective layer 114a is equal to the flexural strength M_{IN} (N) of the inner insulating protective layer 114b.

Thus, the conventional positive electrode connection portion 113 including the insulating protective layer 114 is difficult to bend. When the opposing parts of the positive electrode connection portion 113 are joined to one another, the positive electrode connection portion 113 is bent at the foil-joining start position P₁ located at the insulating protective layer end 114e. The insulating protective layer end 114e corresponds to an application end where the insulating protective layer 114 ends and the metal foil is exposed.

### Foil-Joining State of Positive Electrode Connection Portion 113 of Present Embodiment

In the lithium-ion rechargeable battery 1 of the present embodiment, when the portion of the positive electrode plate 110 corresponding to the insulating protective layer 114 is set such that “yield stress X≤0.122 N” is satisfied, the positive electrode connection portion 113 held between the insulating protective layers 114 becomes easily bent. Thus, as shown in FIG. 7, when a part of the positive electrode connection portion 113 is pulled to be joined with the other opposing parts, the positive electrode connection portion 113, held between the insulating protective layers 114 that contact the negative electrode slit end 100e via the separator 120, is bent at the foil-joining start position P₁.

FIG. 9 is a schematic diagram showing the foil-joining start position PI of another typical positive electrode connection portion 113. As shown in FIG. 9, when a part of the positive electrode connection portion 113 is pulled inward of the electrode body 10 to be joined with the other opposing parts, if the yield stress X (N) of the portion of the positive electrode plate 110 corresponding to the insulating protective layer 114 is too large, the positive electrode connection portion 113 including the insulating protective layer 114 bends the negative electrode plate 100 inward (downward).

In the lithium-ion rechargeable battery 1 of the present embodiment, the portion of the positive electrode plate 110 corresponding to the insulating protective layer 114 is set such that “yield stress X≤0.122 N” is satisfied as the first condition. Thus, the positive electrode connection portion 113 will be arranged being as short as possible without deforming the negative electrode plate 100 as shown in FIG. 9.

### Second Condition (M_{IN}≥0.0372 N)

The inner insulating protective layer 114b is set such that the “flexural strength M_{IN}≥ 0.0372 N” is satisfied as a second condition. Thus, the present embodiment has the following operation.

In a case shown in FIG. 9, when deformation of the positive electrode connection portion 113 including the insulating protective layer 114 becomes excessive, the stress may concentrate and cause damage to the inner separator 120 located between the negative electrode slit end 100e and the positive electrode connection portion 113 including the insulating protective layer 114. This situation is avoidable by increasing M_{IN} (N) by a certain amount.

### Foil-Joining State of Positive Electrode Connection Portion 113 of Present Embodiment

FIG. 7 is a schematic diagram showing the foil-joining start position PI of the positive electrode connection portion 113 in the present embodiment. In the present embodiment, the inner insulating protective layer 114b is set such that “flexural strength M_{IN}≥ 0.0372 N” is satisfied.

Thus, the foil-joining start position P₁ of the positive electrode connection portion 113 is located at the negative electrode slit end 100e of the negative electrode plate 100 regardless of the insulating protective layer 114.

Accordingly, the length of the positive electrode connection portion 113 in the present embodiment required by joining of the opposing parts with the positive electrode current collector 15 becomes longer than that of the conventional positive electrode connection portion 113. In this case, a length W₁ over which the positive electrode current collector 15 contacts the positive electrode connection portion 113 of the present embodiment becomes greater than a length W₂ over which the positive electrode current collector 15 contacts the positive electrode connection portion 113 of the known art. Thus, a larger area is ensured for bonding of the positive electrode current collector 15 and the joined distal end parts of the positive electrode connection portion 113. This improves the conductivity, decreases an internal resistance DC-IR, and increases the mechanical strength of welding.

### Third Condition (Flexural Strength M_{OUT}≥ 0.0343 N)

The lithium-ion rechargeable battery 1 of the present embodiment is characterized in that the outer insulating protective layer 114a is set such that “flexural strength M_{OUT}≥ 0.0343 N” is satisfied.

Thus, the present embodiment has the following operation.

As described with reference to FIG. 7, when the opposing parts of the positive electrode connection portion 113 are joined in the present embodiment, the positive electrode connection portion 113 is bent at the foil-joining start position PI located at the negative electrode slit end 100e of the negative electrode plate 100. In this case, the inner insulating protective layer 114b contacts the negative electrode slit end 100e via the separator 120.

In the lithium-ion rechargeable battery 1 of the present embodiment, the electrode body 10 immediately after the foil-joining, as shown in FIG. 7, is compressed in the thickness direction D to a predetermined thickness.

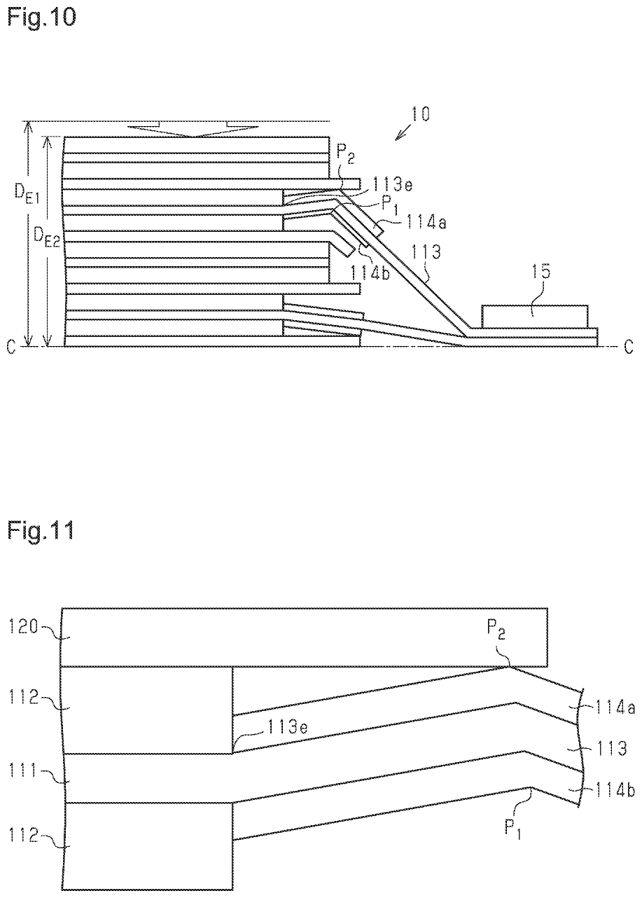

FIG. 10 is a schematic diagram showing a cross section of a conventional electrode body 10 taken along the widthwise direction W when the electrode body 10 is compressed in the thickness direction D in a state in which the opposing parts of the positive electrode connection portion 113 are joined together and welded to the positive electrode current collector 15.

After the opposing parts of the positive electrode connection portion 113 are joined together and welded to the positive electrode current collector 15 to manufacture the lithium-ion rechargeable battery 1, multiple battery cells of the lithium-ion rechargeable battery 1 are stacked and bound by pressure applied with a binding tool in a stacking direction. Then, the stack of battery cells is kept in a high-temperature state in an aging step and the like. In the present embodiment, such step is referred to as “the compression step”.

As shown in FIG. 10, the electrode body 10 has a thickness DEI immediately after the opposing parts of the positive electrode connection portion 113 are joined together and welded to the positive electrode current collector 15. Then, the electrode body 10 is compressed to a thickness D_{E2} as shown in FIG. 10 when the electrode body 10 is bound in a high-temperature state in an aging step and the like. In this case, although the thickness DEI of the electrode body 10 is compressed to the thickness D_{E2}, the length of the positive electrode connection portion 113 has not changed. As a result, an outer bent point P₂ of the bent outer insulating protective layer 114a is pushed upward with respect to the electrode body 10. Thus, the outer bent point P₂ shown in FIG. 10 comes into contact with the upper (outer) separator 120 as shown in FIG. 10.

### Conventional Electrode Body 10 After Compression Step

FIG. 11 is a schematic diagram showing contact between the conventional outer insulating protective layer 114a and the separator 120 shown in FIG. 10. The conventional lithium-ion rechargeable battery 1 does not take into consideration the yield stress X (N) of the insulating protective layer 114, the flexural strength M_{OUT} of the outer insulating protective layer 114a, or the flexural strength M_{IN} (N) of the inner insulating protective layer 114b.

Accordingly, there is not enough distance between the separator 120 and the outer bent point P₂ before bending, and the outer bent point P₂ comes into contact with the separator 120 after the compression step. This applies a large load to the outer insulating protective layer 114a and the positive electrode substrate 111.

### Electrode Body 10 of Present Embodiment After Compression Step

In the lithium-ion rechargeable battery 1 of the present embodiment, the flexural strength M_{OUT} of the outer insulating protective layer 114a satisfies “flexural strength M_{OUT}≥0.0343 N”.

The positive electrode connection portion 113 including the insulating protective layer 114 is less easily bent than the positive electrode connection portion 113 without the insulating protective layer 114. Thus, deformation caused by the compression step mainly occurs in a part of the positive electrode connection portion 113 where the insulating protective layer 114 is not formed. Further, the flexural strength M_{OUT} of the outer insulating protective layer 114a is set such that “flexural strength M_{OUT}≥ 0.0343 N” is satisfied. This restricts increases in a bending angle of the outer insulating protective layer 114a at the outer bent point P₂. As a result, the outer insulating protective layer 114a avoids such deformation at the outer bent point P₂ that strongly presses the separator 120. In other words, in the lithium-ion rechargeable battery 1 of the present embodiment, the flexural strength M_{OUT} of the outer insulating protective layer 114a is set such that “flexural strength M_{OUT}≥ 0.0343 N” is satisfied, thereby reducing the load on the outer separator 120.

### Experimental Examples of Present Embodiment

### Preparation of Experiment

FIG. 13 is a table showing the results of experimental examples. In these experiments, Examples 1 to 2 and Comparative Examples 1 to 3 had the same negative electrode plate 100, separators 120, positive electrode substrate 111, and positive electrode mixture layer 112.

The following experiments were conducted on the electrode body 10 of the present embodiment structured as described above.

First condition: the yield stress X (N) of the portion of the positive electrode plate 110 corresponding to the insulating protective layer 114 was changed and compared.

Second condition: the flexural strength M_{IN} (N) of the inner insulating protective layer 114b was changed and compared.

The third condition: the flexural strength M_{OUT} (N) of the outer insulating protective layer 114a was changed and compared.

### Conditions of Experiment

### Example 1

For the first condition, the yield stress X was set to 0.0333 N. For the second condition, the flexural strength M_{IN} was set to 0.0372 N. For the third condition, the flexural strength M_{OUT} was set to 0.0343 N.

### Example 2

For the first condition, the yield stress X was set to 0.1225 N. For the second condition, the flexural strength M_{IN} was set to 0.0695 N. For the third condition, the flexural strength M_{OUT} was set to 0.0451 N.

### Comparative Example 1

For the first condition, the yield stress X was set to 0.1270 N. For the second condition, the flexural strength M_{IN} was set to 0.0735 N. For the third condition, the flexural strength M_{OUT} was set to 0.0441 N.

### Comparative Example 2

For the first condition, the yield stress X was set to 0.0284 N. For the second condition, the flexural strength M_{IN} was set to 0.0343 N. For the third condition, the flexural strength M_{OUT} was set to 0.0392 N.

### Comparative Example 3

For the first condition, the yield stress X was set to 0.0500 N. For the second condition, the flexural strength M_{IN} was set to 0.0539 N. For the third condition, the flexural strength M_{OUT} was set to 0.0314 N.

The evaluations were determined based on whether the following effects were observed.

Effect (1): It was determined whether the foil-joining start position P₁ was located at the negative electrode slit end 100e or the insulating protective layer end 114e when the opposing parts of the positive electrode connection portion 113 were joined with one another.

The evaluation of “satisfactory” was given when the foil-joining start position P₁ was at the negative electrode slit end 100e. The evaluation of “poor” was given when the foil-joining start position P₁ was at the insulating protective layer end 114e.

Effect (2): It was determined whether damage to the inner separator 120 caused by bending of the positive electrode connection portion 113 including the insulating protective layer 114 was avoided.

The evaluation of “satisfactory” was given when the inner separator 120 was not damaged by the bent positive electrode connection portion 113 including the insulating protective layer 114. The evaluation of “poor” was given when the inner separator 120 was damaged by the bent positive electrode connection portion including the insulating protective layer 114.

Effect (3): It was determined whether bending of the positive electrode connection portion 113 was restricted to an extent at which the outer bend point P₂ of the outer insulating protective layer 114a does not contact the separator 120 after the compression step.

The evaluation of “satisfactory” was given when bending of the positive electrode connection portion 113 was restricted to an extent at which the outer bent point P₂ of the outer insulating protective layer 114a does not contact the outer separator 120 after the compression step. The evaluation of “poor” was given when bending of the positive electrode connection portion 113 was not restricted such that the outer bent point P₂ of the outer insulating protective layer 114a contacts the outer separator 120 after the compression step.

### Experiment Results

### Example 1

The first, second, and third conditions were satisfied. As a result, the foil-joining start position was at the negative electrode slit end 100e, which is “satisfactory”, damage to the inner separator 120 was “not observed”, which is “satisfactory”, and restriction of bending of the positive electrode was “observed”, which is “satisfactory”. That is, every determination was “satisfactory”.

### Example 2

The first, second, and third conditions were satisfied. As a result, the foil-joining start position was at the negative electrode slit end 100e, which is “satisfactory”, damage to the inner separator 120 was “not observed”, which is “satisfactory”, and restriction of bending of the positive electrode was “observed”, which is “satisfactory”. That is, every determination was “satisfactory”.

### Comparative Example 1

The second and third conditions were satisfied, but the first condition was not satisfied. As a result, damage to the inner separator 120 was “not observed”, which is “satisfactory”, and restriction of bending of the positive electrode was “observed”, which is “satisfactory”. However, the foil-joining start position was at the insulating protective layer end 114e, which is “poor”.

### Comparative Example 2

The first and third conditions were satisfied, but the second condition was not satisfied. As a result, the foil-joining start position was at the negative electrode slit end 100e, which is “satisfactory”, and restriction of bending of the positive electrode was “observed”, which is “satisfactory”. However, damage to the inner separator 120 was “observed”, which is “poor”.

### Comparative Example 3

The first and second conditions were satisfied, but the third condition was not satisfied. As a result, the foil-joining start position was at the negative electrode slit end 100e, which “satisfactory”, and damage to the inner separator 120 was “not observed”, which is “satisfactory”. However, restriction of bending of the positive electrode was “not observed”, which is “poor”.

### Summary of Experiment

In Example 2 of the above experiment, in which the yield stress X was set to 0.1225 N, the foil-joining start position P₁ was at the negative electrode slit end 100e. However, in Comparative Example 1, in which the yield stress X was set to 0.1270 N, the foil-joining start position P₁ was at the insulating protective layer end 114e. This indicates that as long as “yield stress X≤0.1225 N” is satisfied, the foil-joining start position PI will be at the negative electrode slit end 100e.

Further, in Example 1, in which the flexural strength M_{IN} was set to 0.0372 N, damage to the inner separator 120 was avoided. However, in Comparative Example 2, in which flexural strength M_{IN} was set to 0.0343 N, damage to the inner separator 120 was not avoided. This indicates that as long as the inner insulating protective layer 114b is set such that “flexural strength M_{IN}≥0.0372 N” is satisfied, damage to the inner separator 120 is avoided when the opposing parts of the positive electrode connection portion 113 are joined to one another.

Furthermore, in Example 1, in which the flexural strength M_{OUT} was set to 0.0343 N, bending of the positive electrode connection portion 113 was restricted. However, in Comparative Example 3, in which the flexural strength M_{OUT} was set to 0.0314 N, bending of the positive electrode connection portion 113 was not restricted. This indicates that as long as the following condition is satisfied, bending of the positive electrode connection portion 113 is restricted to an extent at which the outer bent point P₂ of the outer insulating protective layer 114a does not contact the outer separator 120 after the compression step. Specifically, as long as “flexural strength M_{OUT}≥0.0343 N” is satisfied, bending of the positive electrode connection portion 113 is restricted to an extent at which the outer bent point P₂ of the outer insulating protective layer 114a does not contact the outer separator 120 after the compression step.

### Advantages of Present Embodiment

(1) The lithium-ion rechargeable battery 1 of the present embodiment including the insulating protective layer 114 reduces the load on the separator 120 and the like.

(2) In the present embodiment, in a state in which the positive electrode mixture layer 112 is fixed, the measurement point 114f is set to the contact point where the needle tip 43a of the probe 43 contacts the outer insulating protective layer 114. The contact point is located at the distance L (=3 mm) from the end 112e, which corresponds to the boundary of the applied mixture. Then, the response load F (N) and the displacement amount S (mm) are measured by pressing the needle tip 43a of the probe 43 against the insulating protective layer 114. The yield stress X (N) corresponds to the response load F (N) corresponding to when the correlation of the response load F (N) and the displacement amount S (mm) is broken. The flexural strength M (N) is obtained by calculating “M (N)=FL/S”. In this case, the yield stress X is set such that “yield stress X≤0.122 N” is satisfied. Thus, the foil-joining start position P₁ is located at negative electrode slit end 100e.

(3) In the present embodiment, the flexural strength M_{IN} (N) of the inner insulating protective layer 114b formed on a surface of the positive electrode connection portion 113 that is located toward the positive electrode current collector 15 in the stacking direction of the electrode body 10 is set such that “M_{IN}≥0.0372 N” is satisfied. This avoids damage to the inner separator 120.

(4) In the present embodiment, in the positive electrode connection portion 113 where the opposing parts are joined to the positive electrode current collector 15, the flexural strength M_{OUT} of the outer insulating protective layer 114a formed on a surface of the positive electrode connection portion 113 that is located away from the positive electrode current collector 15 in the stacking direction of the stacked electrode body 10 is set such that “M_{OUT}≥ 0.0343 N” is satisfied. This restricts bending of the positive electrode connection portion 113 to an extent at which the outer bent point P₂ of the outer insulating protective layer 114a does not contact the outer separator 120 after the compression step.

(5) The yield stress X (N) is not limited to that in the description of the embodiment, and may be set to an appropriate value through experiments so that the foil-joining start position P₁ is at the negative electrode slit end 100e. In the same manner, the flexural strength M_{IN} (N) may set to an appropriate value through experiments so that damage to the inner separator 120 is avoided. Further, the flexural strength M_{OUT} (N) may be set to an appropriate value through experiments so that bending of the positive electrode connection portion 113 is restricted to an extent at which the outer bent point P₂ of the outer insulating protective layer 114a does not contact the outer separator 120 after the compression step.

(6) Each of the yield stress X (N), the flexural strength M_{IN} (N), and the flexural strength M_{OUT} (N) may be set to an appropriate value such that the performance of the lithium-ion rechargeable battery 1 is improved as a whole.

(7) The advantages of the present embodiment become more pronounced when the rolled-type electrode body 10 is accommodated in a box-shaped battery case 11, particularly, for a purpose of being mounted on a vehicle or the like.

### Other Examples

In the present embodiment, “L=3 mm” is satisfied. However, the value may be changed in accordance with the strength of the positive electrode plate 110. Further, in the present embodiment, a strip of the test piece 40 having a length of 50 mm was prepared from the positive electrode plate 110 in a direction (direction W) orthogonal to the direction in which the positive electrode mixture layer 112 is applied. However, there is no limit to such a structure.

In the present embodiment, the flexural strength M (N) is calculated from “flexural strength M (N)=response load F (N)× distance L (mm)/displacement amount S”. The flexural strength M (N) may be obtained in terms of an angle θ by using “sin θ≈displacement amount S (mm)/distance L (mm)” for the displacement amount S (mm).

The drawings in FIGS. 1 to 13 are illustrated for simplicity and clarity and are not intended to limit the number of turns of the electrode body 10, the number of layers in the electrode body 10, the balance between thickness, width, and length of the electrode body 10, the shifted amounts of the positive and negative electrode plates, angles, and the like.

The preferred numerical ranges described in the present embodiment are merely examples, and one skilled in the art can optimize the numerical ranges in accordance with the configurations, materials, and the like of the battery.

The present embodiment describes an example of the lithium-ion rechargeable battery 1 mounted on a vehicle. However, the present disclosure is not limited to such purpose and is also applicable to a lithium-ion rechargeable battery 1 used in stationary power storage equipment.

In the embodiment, the stack of the electrode body 10 is rolled and then flattened. However, the rolled-type lithium-ion rechargeable battery 1 does not have to be flattened. For example, the rolled-type electrode body 10 may be columnar. Further, the present embodiment may be applied to a laminated-type electrode body 10 in which a number of substantially rectangular positive electrode plates 110, negative electrode plates 100, and separators 120 are stacked. In this case, the positive and negative electrode plates each include a corresponding one of the negative electrode connection portion 103 and the positive electrode connection portion 113.

The lithium-ion rechargeable battery 1 is an embodiment of the present disclosure. It should be apparent to one skilled in the art that the lithium-ion rechargeable battery 1 is not limited the embodiment and can be implemented by adding, deleting, or changing the structure without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous electrolyte rechargeable battery, comprising:
an electrode body including a stack of a negative electrode plate, a positive electrode plate, and a separator arranged between the positive electrode plate and the negative electrode plate, wherein:
the negative electrode plate includes
a negative electrode substrate formed by a strip of a metal foil having a uniform width,
a negative electrode mixture layer formed on each of two opposite surfaces of the negative electrode substrate, and
a negative electrode connection portion defined on the negative electrode substrate where the negative electrode mixture layer is not formed at one end of the electrode body in a widthwise direction;
the positive electrode plate includes
a positive electrode substrate formed by a strip of a metal foil having a uniform width,
a positive electrode mixture layer formed on each of two opposite surfaces of the positive electrode substrate,
a positive electrode connection portion defined on the positive electrode substrate where the positive electrode mixture layer is not formed at an other end of the electrode body in the widthwise direction, and
an insulating protective layer arranged on each of two opposite surfaces of the positive electrode connection portion, the insulating protective layer being adjacent to the positive electrode mixture layer and facing the negative electrode mixture layer;
a negative electrode current collector bonded to the negative electrode connection portion at where opposing parts of the negative electrode connection portion are joined to one another at the one end of the electrode body in the widthwise direction; and
a positive electrode current collector bonded to the positive electrode connection portion at where opposing parts of the positive electrode connection portion are joined to one another at the other end of the electrode body in the widthwise direction, wherein:
in a state in which the positive electrode mixture layer is fixed, a tip of a needle is pressed against the insulating protective layer at a contact point where the tip of the needle contacting the insulating protective layer is located at a certain distance L (mm) from a boundary between where the positive electrode mixture layer is formed and where the positive electrode mixture is not formed to measure a response load F (N) and a displacement amount S (mm), the response load F (N) being measured when a correlation of the response load F (N) and the displacement amount S (mm) is broken corresponds to a yield stress X (N); and
a flexural strength M (N) is obtained by calculating “M (N)=FL/S”,
in the insulating protective layer formed on each of the two opposite surfaces of the positive electrode connection portion, the yield stress X (N) of the positive electrode plate is set such that “X≤0.122 N” is satisfied; and
“M_{IN}≥0.0372 N” is satisfied, where M_{IN} (N) represents a flexural strength of the positive electrode plate including only an inner insulating protective layer formed on a surface of the positive electrode connection portion that is located toward the positive electrode current collector in a stacking direction of the electrode body.

2. The non-aqueous electrolyte rechargeable battery according to claim 1, wherein, in the positive electrode connection portion where the opposing parts are joined to one another and bonded to the positive electrode current collector, “M_{OUT} (N)≥0.0343” is satisfied, where M_{OUT} (N) represents the flexural strength (N) of the positive electrode plate including only an outer insulating protective layer formed on a surface of the positive electrode connection portion that is located away from the positive electrode current collector in the stacking direction of the electrode body.

3. The non-aqueous electrolyte rechargeable battery according to claim 1, wherein the electrode body is a rolled-type electrode body in which the stack is rolled and flattened.

4. A non-aqueous electrolyte rechargeable battery, comprising:
an electrode body including a stack of a negative electrode plate, a positive electrode plate, and a separator arranged between the positive electrode plate and the negative electrode plate, wherein:
the negative electrode plate includes
a negative electrode substrate formed by a strip of a metal foil having a uniform width,
a negative electrode mixture layer formed on each of two opposite surfaces of the negative electrode substrate, and
a negative electrode connection portion defined on the negative electrode substrate where the negative electrode mixture layer is not formed at one end of the electrode body in a widthwise direction;
the positive electrode plate includes
a positive electrode substrate formed by a strip of a metal foil having a uniform width,
a positive electrode mixture layer formed on each of two opposite surfaces of the positive electrode substrate,
a positive electrode connection portion defined on the positive electrode substrate where the positive electrode mixture layer is not formed at an other end of the electrode body in the widthwise direction, and
an insulating protective layer arranged on each of two opposite surfaces of the positive electrode connection portion, the insulative protective layer being adjacent to the positive electrode mixture layer and facing the negative electrode mixture layer;
a negative electrode current collector bonded to the negative electrode connection portion at where opposing parts of the negative electrode connection portion are joined to one another at the one end of the electrode body in the widthwise direction; and
a positive electrode current collector bonded to the positive electrode current collector at where opposing parts of the positive electrode connection portion are joined to one another at the other end of the electrode body in the widthwise direction, wherein:
in a state in which the positive electrode mixture layer is fixed, a tip of a needle is pressed against the insulating protective layer at a contact point where the tip of the needle contacting the insulating protective layer is located at a distance L (mm) from a boundary between where the positive electrode mixture layer is formed and where the positive electrode mixture is not formed to measure a response load F (N) and a displacement amount S (mm), the response load F (N) being measured when a correlation of the response load F (N) and the displacement amount S (mm) is broken corresponds to a yield stress X (N); and
a flexural strength M (N) is obtained by calculating “M (N)=FL/S”,
in the insulating protective layer formed on each of the two opposite surfaces of the positive electrode connection portion, X (N) represents the yield stress (N) of the positive electrode plate, and M_{IN} (N) represents the flexural strength of the positive electrode plate including only an inner insulating protective layer formed on a surface of the positive electrode connection portion that is located toward the positive electrode current collector in a stacking direction of the electrode body; and
the yield stress X (N) and the flexural strength M_{IN} (N) of the positive electrode plate are set such that the positive electrode connection portion, where the opposing parts are joined to one another and bonded to the positive electrode current collector, is bent at an end of the negative electrode mixture layer, formed on a surface of the negative electrode substrate that is located away from the positive electrode current collector in the stacking direction of the electrode body, with the separator located in between.

5. The non-aqueous electrolyte rechargeable battery according to claim 4, wherein
when M_{OUT} (N) represents the flexural strength (N) of the positive electrode plate including only an outer insulating protective layer formed on a surface of the positive electrode connection portion that is located away from the positive electrode current collector in the stacking direction of the electrode body,
in the positive electrode connection portion where the opposing parts are joined to one another and bonded to the positive electrode current collector, the flexural strength M_{OUT} (N) is set to restrict bending of the positive electrode plate such that the outer insulating protective layer, formed on a surface of the positive electrode connection portion that is located away from the positive electrode current collector in the stacking direction of the electrode body, does not contact the separator.
